(19) United States
(12) Patent Application Publication
(10) Pub. No.: US 2023/0198065 A1
(43) Pub. Date: Jun. 22, 2023

(54) SEALED BATTERY

(71) Applicant: Prime Planet Energy & Solutions, Inc., Tokyo (JP)

(72) Inventors: Naoya TADA, Himeji-shi (JP); Hiroshi TAKABAYASHI, Koriyama-shi (JP); Kazuki OSHIMA, Himeji-shi (JP)

(21) Appl. No.: 18/085,585

(22) Filed: Dec. 21, 2022

(30) Foreign Application Priority Data
Dec. 22, 2021 (JP) 2021-208279

(51) Int. Cl. H01M 50/184; H01M 50/148; H01M 50/645; H01M 50/102; H01M 50/131

(52) U.S. Cl. CPC H01M 50/184; H01M 50/148; H01M 50/645; H01M 50/102; H01M 50/131

(57) ABSTRACT

The herein-disclosed sealed battery includes a sealing plate, a sealing plug comprising a flange part opposed to an outer surface of the sealing plate, and a sealing member disposed between the sealing plate and the flange part of the sealing plug. Then, regarding the herein-disclosed sealed battery, the outer surface of the sealing plate and an opposed surface of the flange part include a rough surface area R on at least a part of a portion contacting with the sealing member and an arithmetic average roughness Sa of the rough surface area is equal to or more than 1 μm. By doing this, it is possible to suppress a liquid leakage of an electrolyte.

### CROSS REFERENCE TO RELATED APPLICATIONS

The present application claims the priority based on Japanese Patent Application No. 2021-208279 filed on Dec. 22, 2021, the entire contents of which are incorporated in the present specification by reference.

### BACKGROUND

### 1. Technical Field

The present disclosure relates to the sealed battery.

### 2. Description of the Related Art

A secondary battery, such as a lithium ion secondary battery and a nickel hydrogen battery, is widely used in various fields, for example, a power supply mounted on a vehicle or a power supply for a portable terminal. As one example for a structure of this secondary battery, a sealed battery is known. The sealed battery is constructed by accommodating an electrode body and an electrolyte inside a metal battery case in a sealed state. On this battery case of the sealed battery, a liquid injection hole is provided for injecting the electrolyte into the battery case. The liquid injection hole is normally sealed with a sealing plug after the electrolyte is injected.

JP2015-99670 discloses a technique that is related to a sealing structure configured to seal the liquid injection hole of the battery case. The sealed battery described in this cited document includes a battery case provided with the liquid injection hole for injecting an electrolyte, and includes a blind rivet (sealing plug) configured to seal the liquid injection hole. Then, the blind rivet described in JP2015-99670 includes a sleeve including a flange part whose diameter is larger than a diameter of the liquid injection hole and including a bottomed and cylindrical sleeve main body part positioned in the battery case, and includes a residual member remaining inside the sleeve. Then, this residual member of the blind rivet includes a projection part that protrudes toward a bottom part of the sleeve. Regarding the sealed battery including the configuration as described above, it is possible to form an opening for gas exhaust by pressing the residual member toward the bottom part of the sleeve and by thrusting the projection part into the bottom part of the sleeve. By doing this, it is possible to exhaust gas through the liquid injection hole to an outside of the battery case when the gas is generated due to an overcharge, or the like.

### SUMMARY

Anyway, regarding the sealing structure of the liquid injection hole, a sealing member (resin washer, or the like) made of resin might be arranged between the sealing plug and the battery case. By doing this, it is possible to inhibit liquid leakage of the electrolyte from a gap between the sealing plug and the battery case. This sealing member is normally attached in a state of being positioned and pressurized between the battery case and the sealing plug. By the sealing member rebounding to this pressure, it is possible to cover the microscopic gap between the sealing plug and the battery case. However, there is a fear that, if the sealing member is degradated by exposure to a high temperature environment, aging degradation, or the like, the sealing member is deformed by pressure from the battery case and from the sealing plug. In that situation there is a fear that a gap is generated between respective members (sealing plug, sealing member, battery case) configuring the sealing structure so as to cause the liquid leakage.

The present disclosure has been made in view of the above described circumstances, and the main object is to provide a sealed battery that can suppress the liquid leakage; of the electrolyte caused by degradation of the sealing member on the sealing structure of the liquid injection hole.

In order to deal with the above-described object, a herein-disclosed sealed battery is provided.

The herein-disclosed sealed battery includes a battery case, a sealing plug, and a sealing member. A battery case includes a liquid injection hole. A sealing plug is attached to a liquid injection hole and includes an opposed surface being opposed to a surface of a battery case at a periphery of a liquid injection hole. A sealing member is made of resin and is disposed between a battery case and a sealing plug. Then, a surface of a battery case and/or an opposed surface of a sealing plug includes a rough surface area on at least a part of a portion contacting with a sealing member, and an arithmetic average roughness Sa of a rough surface area is equal to or more than 1 μm.

The herein-disclosed sealed battery includes a sealing structure in which the sealing plug is attached to the liquid injection hole, and the sealing plug is disposed between the battery case and the sealing member. When the sealing member is degradated in the sealed battery configured as described above, the sealing member is deformed to an outside in the diameter direction with the liquid injection hole being treated as a center. On the other hand, in the herein-disclosed sealed battery, the rough surface area (area whose arithmetic average roughness Sa is equal to or more than 1 μm) is formed on at least one among the surface of the battery case and the opposed surface of the sealing plug. By doing this, it is possible to increase the friction force between the sealing member and the surface of the battery case (and/or opposed surface of the sealing plug), and thus it is possible to regulate the deformation of the sealing member toward the outside in the diameter direction. By doing this, it is possible to inhibit generation of a gap between respective members configuring the sealing structure, and thus it is possible to suppress the liquid leakage of the electrolyte caused by degradation of the sealing member. In addition, this kind of rough surface area has an advantage of being formed easily even on a very fine part, such as the sealing plug.

In one aspect of the herein-disclosed sealed battery, a sealing plug includes a shaft part that is inserted into a liquid injection hole and includes a flange part that is formed in a plate shape and extends from a shaft part along an outer surface of a battery case at an outside of a battery case. A sealing member is disposed between an outer surface of a battery case and an opposed surface of a flange part. An outer surface of a battery case and/or an opposed surface of a flange part includes a rough surface area on at least a part of a portion contacting with a sealing member.

As one example for the sealing structure of the liquid injection hole, it is possible to use a structure in which the sealing member is arranged at an outer surface side of the battery case. In that situation, the flange part is formed in a plate shape on the sealing plug to extend along the outer surface of the battery case, and the sealing member is disposed between the flange part and the battery case. When the sealing structure configured as described above is used, it is preferable to form the rough surface area on the outer surface of the battery case and/or the opposed surface of the flange part. By doing this, it is possible to suitably suppress the liquid leakage caused by the degradated deformation of the sealing member.

In one aspect of the herein-disclosed sealed battery, a projection part protruding toward a sealing member and surrounding a liquid injection hole in a plane view is formed on a surface of a battery case and/or an opposed surface of a sealing plug.

The above-described projection part surrounding the liquid injection hole works as an obstacle that interrupts deformation of the sealing member toward an outward in the diameter direction with the liquid injection hole being treated as the center, and thus it is possible to further suitably suppress the liquid leakage caused by the degradated deformation of the sealing member.

In one aspect of the herein-disclosed sealed battery, a surface of a battery case and/or an opposed surface of a sealing plug includes a rough surface area on a part equal to or more than 5% of a portion contacting with a sealing member.

By securing the rough surface area whose size is equal to or more than a predetermined size as described above, the friction force between the battery case and the sealing member (and/or the friction force between the sealing plug and the sealing member) can be properly enhanced, and thus it is possible to further suitably suppress the liquid leakage caused by the degradated deformation of the sealing member.

In one aspect of the herein-disclosed sealed battery, an arithmetic average roughness Sa of a rough surface area is equal to or less than 100 μm.

From a perspective of regulating the degradated deformation of the sealing member, the upper limit of the arithmetic average roughness Sa of the rough surface area is not particularly restricted. However, from a perspective of simplifying the process for forming the rough surface area so as to enhance the manufacture efficiency, it is preferable that the arithmetic average roughness Sa of the rough surface area is equal to or less than 100 μm.

### BRIEF DESCRIPTION OF THE DRAWINGS

FIG. 1 is a cross section view that schematically shows a sealed battery in accordance with one embodiment.

FIG. 2 is an enlarged cross section view of a sealing structure of a liquid injection hole on the sealed battery in accordance with one embodiment.

### DETAILED DESCRIPTION

Below, an embodiment of a herein-disclosed technique will be explained while referring to drawings. Incidentally, the mailers other than matters particularly mentioned in this specification and required for practicing the present disclosure (for example, manufacture process, or the like) can be grasped as design matters of those skilled in the art based on the related art in the present field. The herein-disclosed technique can be executed based on the contents disclosed in the present specification, and the technical common sense in the present field. Incidentally, a wording “A to B” representing a range in the present specification semantically covers not only a meaning of being “equal to or more than A and equal to or less than B”, but also meanings of “preferably more than A” and “preferably less than B”.

### Embodiment 1

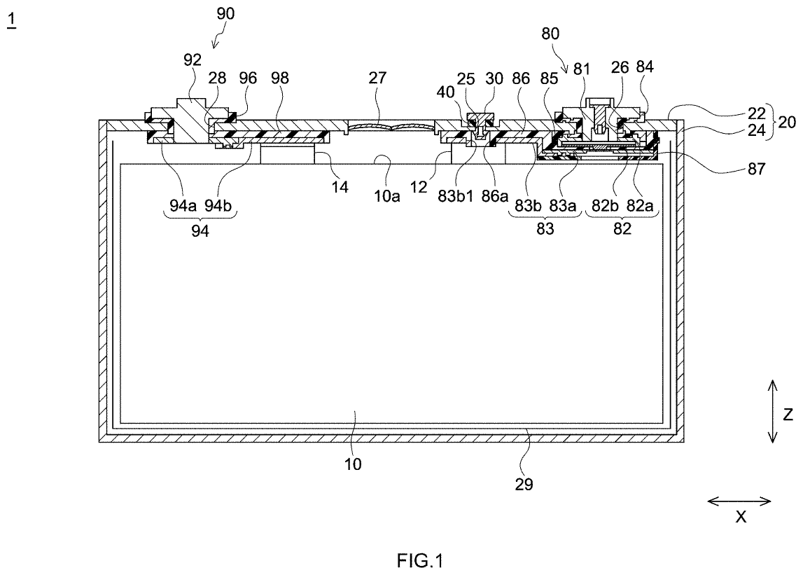

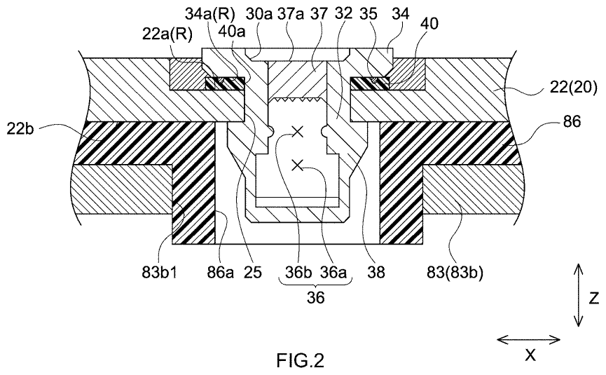

FIG. 1 is a cross section view that schematically shows a sealed battery in accordance with the present embodiment. FIG. 2 is an enlarged cross section view of a sealing structure of a liquid injection hole on the sealed battery in accordance with the present embodiment. Incidentally, in each drawing, a reference sign X represents “width direction (of the sealed battery)”, and a reference sign Z represents “height direction”. However, these are directions defined for convenience sake of explanation, and thus it is not intended to restrict a disposed form of the sealed battery at a manufacturing time or at a use time.

As shown in FIG. 1, the sealed battery 1 in accordance with the present embodiment includes an electrode body 10, and a battery case 20 configured to accommodate the electrode body 10. In addition, as the illustration is omitted, the battery case 20 at the inside accommodates an electrolyte, in addition to the electrode body 10. Below, each configuration of the sealed battery 1 will be described.

1. Electrode Body

The electrode body 10 is a power generating element accommodated inside the battery case 20. The electrode body 10 in the present embodiment is accommodated in the battery case 20 while being covered by an insulating film 29 made of resin. By doing this, it is possible to inhibit conduction between the electrode body 10 and the battery case 20. In addition, although the detailed illustration is omitted, the electrode body 10 in the present embodiment is a laminate electrode body in which plural positive electrode sheets and plural negative electrode sheets are laminated via separators having insulating properties. The positive electrode sheet includes a positive electrode collector foil being an electrically conductive metal foil, and includes a positive electrode composite material layer provided on a surface of the positive electrode collector foil. In addition, the negative electrode sheet includes a negative electrode collector foil being an electrically conductive metal foil, and includes a negative electrode composite material layer provided on a surface of the negative electrode collector foil. Incidentally, regarding materials of configuration parts (positive electrode sheet, negative electrode sheet, separator, or the like) of the electrode body 10, materials similar to ones of a conventionally known general secondary battery can be used without particular restriction, the materials do not characterize the herein-disclosed technique, and thus the detailed explanation is omitted.

In addition, the electrode body 10 in the present embodiment includes a pair of collector tabs protruding upward in a height direction Z from an upper surface 10a of the electrode body 10. In particular, each of plural positive electrode sheets included in the electrode body 10 includes a positive electrode exposed part, on which the positive electrode collector foil is exposed as the positive electrode composite material layer is not provided. This positive electrode exposed part protrudes toward the height direction from a part of the upper surface of the positive electrode sheet. The collector tab at the positive electrode side (positive electrode collector tab 12) is formed by collecting plural foils of the positive electrode exposed parts. On the other hand, each of plural negative electrode sheets included in the electrode body 10 also includes a negative electrode exposed part, on which the negative electrode collector foil is exposed as the negative electrode composite material layer is not provided. This negative electrode exposed part protrudes toward the height direction from a part of the upper surface of the negative electrode sheet, so as to avoid being overlaid on the positive electrode exposed part. Then, the collector tab at the negative electrode side (negative electrode collector tab 14) is formed by collecting plural foils of the negative electrode exposed parts.

2. Electrolyte

The electrolyte is a liquid electrolyte permeated to an inside (typically, between the positive electrode sheet and the negative electrode sheet) the electrode body 10. Regarding the sealed battery 1 in accordance with the present embodiment, charge carriers (for example, lithium ions) move via the electrolyte between the positive electrode sheet and the negative electrode sheet so as to perform charging and discharging. Incidentally, regarding a material of the electrolyte, a material similar to one used in a conventionally known secondary battery can be used without particular restriction, the material does not characterize the herein-disclosed technique, and thus the explanation is omitted.

Incidentally, it is not required for the electrolyte accommodated in the battery case 20 that the entire electrolyte is permeated inside the electrode body 10. For example, a part of the electrolyte might exist as an excess electrolyte at an outside (between the electrode body 10 and the battery case 20) of the electrode body 10. The sealed battery 1 including this excess electrolyte can supply an electrolyte when the electrode body 10 run shortage of the electrolyte at the inside, and thus it is possible to suppress increase in the inside resistance caused by the liquid shortage. On the other hand, the excess electrolyte freely moves inside the battery case 20, and therefore it can cause the liquid leakage of the electrolyte from the liquid injection hole 25. For this circumstance, the herein-disclosed technique can suppress reduction in the sealing property of the sealing structure of the liquid injection hole 25, and thus it is possible to suitably suppress the liquid leakage of the electrolyte even when the excess electrolyte exists. In other words, the herein-disclosed technique can be suitably applied in particular to the sealed battery including the excess electrolyte inside the battery case.

3. Battery Case

The battery case 20 is a metal container configured to accommodate the electrode body 10. The battery case 20 in the present embodiment includes a case body 24 being a bottomed box-shaped member whose upper surface is opened, and includes a sealing plate 22 being a plate-shaped member configured to cover the upper surface opening of the case body 24. Then, it is preferable that these configuration members of the battery case 20 each has a predetermined rigidity and is configured with a lightweight material. For the material as described above, it is possible to use aluminum, aluminum alloy, or the like.

In addition, at a central part of the sealing plate 22 in a width direction X, a gas exhaust valve 27 is formed. The gas exhaust valve 27 is a thin-walled part whose thickness is smaller than the other portions of the battery case 20 (sealing plate 22). This gas exhaust valve 27 is configured to be broken when an internal pressure of the battery case 20 becomes equal to or more than a predetermined value, so as to exhaust the gas generated inside the battery case 20 to the outside. Incidentally, the operating pressure (broken pressure) of the gas exhaust valve 27 is set to become a pressure higher than an operating pressure of a current interrupt device 82 described later.

4. Terminal Structure

Regarding the sealed battery 1 in accordance with the present embodiment, a positive electrode terminal assembly 80 and a negative electrode terminal assembly 90 are provided on the battery case 20 (sealing plate 22). These terminal structures are provided to form an electrically conductive passage from the electrode body 10 to an outside of the battery case 20, without conduction between the electrode body 10 and the battery case 20. Below, each terminal structure will be explained simply. Incidentally, the herein-disclosed sealed battery is not restricted to a content including the following terminal structures.

On one end part (left side in FIG. 1) in a width direction X of the sealing plate 22, a negative insertion hole 28 is formed. To this negative insertion hole 28, the negative electrode terminal assembly 90 is attached. The negative electrode terminal assembly 90 in the present embodiment includes a negative electrode external terminal 92, a negative electrode current collector 94, a negative side gasket 96, and a negative side insulating plate 98. The negative electrode external terminal 92 is a metal member which is inserted into the negative insertion hole 28 and whose part is exposed to an outside of the battery case 20. A lower end part of this negative electrode external terminal 92 is connected to the negative electrode current collector 94. The negative electrode current collector 94 is a plate-shaped metal member that is connected inside the battery case 20 to the negative electrode external terminal 92 and the negative electrode collector tab 14. Incidentally, the negative electrode current collector 94 in the present embodiment is formed by combining a first part 94a connected to the negative electrode external terminal 92 and a second part 94b connected to the negative electrode collector tabs 14. In addition, the negative side gasket 96 is a resin-made insulating member that is disposed at an outside of the battery case 20 between the negative electrode external terminal 92 and the sealing plate 22. On the other hand, the negative side insulating plate 98 is a resin-made insulating member that is disposed at an inside of the battery case 20 between the negative electrode current collector 94 and the sealing plate 22. By attaching these members to the negative insertion hole 28, it is possible to form an electrically conductive passage from the negative electrode collector tab 14 of the electrode body 10 to an outside of the battery case 20, without conduction between the electrode body 10 and the battery case 20.

While, on the other end part (right side in FIG. 1) in the width direction X of the sealing plate 22, a positive insertion hole 26 is formed. To this positive insertion hole 26, the positive electrode terminal assembly 80 is attached. The positive electrode terminal assembly 80 in the present embodiment includes a positive electrode external terminal 81, a current interrupt device 82, a positive electrode current collector 83, a positive side gasket 84, a positive side insulating plate 85, a current collector holder 86, and a current collector cover 87. The positive electrode external terminal 81 is a metal member which is inserted into the positive insertion hole 26 and whose one part is exposed to an outside of the battery case 20. The current interrupt device 82 is a conductive member that is configured to connect the positive electrode external terminal 81 and the positive electrode current collector 83 inside the battery case 20. This current interrupt device 82 includes a sealing tab 82a connected to the positive electrode external terminal 81 and an inversion plate 82b connected to the sealing tab 82a and the positive electrode current collector 83. A thickness of the inversion plate 82b is adjusted, to make the inversion plate be deformed toward an upward in a height direction Z and then be spaced away from the positive electrode current collector 83 (first part 83a) when an internal pressure of the battery case 20 rises to be equal to or more than a predetermined value. By doing this, it is possible, when an abnormality is caused, to interrupt the electrically conductive passage between the positive electrode current collector 83 and the current interrupt device 82 so as to automatically stop charging and discharging. In addition, the positive electrode current collector 83 is a metal member that is connected to the positive electrode collector tab 12 inside the battery case 20. The positive electrode current collector 83 in the present embodiment is formed by combining the first part 83a connected to the inversion plate 82b of the current interrupt device 82 and a second part 83b connected to the positive electrode collector tabs 12. In addition, the positive side gasket 84 is a resin-made insulating member that is disposed between the positive electrode external terminal 81 and the sealing plate 22. The positive side insulating plate 85 is a resin-made insulating member that is disposed between the current interrupt device 82 (sealing tab 82a) and the sealing plate 22. In addition, the current collector holder 86 is a long insulating member that extends in the width direction X. One end part (left side in FIG. 1) in the width direction X of the current collector holder 86 is disposed between the positive electrode current collector 83 (second part 83b) and an inner surface of the sealing plate 22. In addition, the other end part (right side in FIG. 1) in the width direction X of the current collector holder 86 is disposed between the current interrupt device 82 (inversion plate 82b) and the positive electrode current collector 83 (first part 83a). Then, the current collector cover 87 is a resin-made insulating member that is configured to cover a lower surface of the positive electrode current collector 83, By attaching each of the above-described members to the positive insertion hole 26, it is possible to form the electrically conductive passage from the positive electrode collector tab 12 of the electrode body 10 to an outside of the battery case 20, without conduction between the electrode body 10 and the battery case 20. Incidentally, regarding the sealed battery 1 in accordance with the present embodiment, opening parts 83b1, 86a are formed on the second part 83b of the positive electrode current collector 83 and on the current collector holder 86, to avoid interfering with a later-described sealing plug 30 and the positive electrode terminal assembly 80.

5. Sealing Structure of Liquid Injection Hole

The liquid injection hole 25 is formed on the sealing plate 22 in the present embodiment. The liquid injection hole 25 is opened at a manufacturing step of the sealed battery 1, and the electrolyte is injected to an inside of the battery case 20 through the liquid injection hole 25. Then, the sealing plug 30 is attached to this liquid injection hole 25 after the liquid injection of the electrolyte, and then the liquid injection hole is sealed. In addition, a resin-made sealing member 40 is arranged between the sealing plug 30 and the battery case 20 (sealing plate 22), By doing this, the gap between the sealing plug 30 and the sealing plate 22 is closed, and thus it is possible to inhibit the liquid leakage from the liquid injection hole 25. Below, the sealing structure of the liquid injection hole 25 will be explained particularly, while referring to FIG. 2.

The sealing plug 30 shown in FIG. 2 is a sealing plug being a blind rivet type. A top end part of the sealing plug 30 is exposed to an outside of the battery case 20, and a lower end part is accommodated into the battery case 20. This sealing plug 30 includes a shaft part 32 inserted into the liquid injection hole 25, and includes a plate-shaped flange part 34 extending from the shaft part 32 at an outside of the battery case 20 along an outer surface of the battery case (outer surface 22a of the sealing plate 22). The shaft part 32 is a cylindrical portion including an inside cavity 36. This inside cavity 36 includes a large diameter part 36a formed at a lower part of the shall part 32, and includes a small diameter part 36b formed at an upper part of the shaft part 32. In addition, a head part 37 of a mandrel is accommodated in the small diameter part 36b of the inside cavity 36, The mandrel is a rod-shaped member that extends upward in the height direction Z from the upper surface 37a of the head part 37. As described later, the mandrel is removed at a process for attaching the sealing plug 30 to the liquid injection hole 25, and thus is not shown in FIG. 2. In addition, on an outer circumferential surface of the shaft part 32, a lock part 38 protruding toward an outside in a diameter direction is formed. By this lock part 38 being locked to an inner surface 22b of the sealing plate 22, the sealing plug 30 is fixed to the sealing plate 22.

A procedure for attaching the sealing plug 30 to the liquid injection hole 25 will be described. The shaft part 32 of the sealing plug 30 before being attached to the sealing plate 22 is molded in a cylindrical shape whose outer circumferential surface includes no concave and convex part (lock part 38 is not formed). Then, regarding this sealing plug 30 before being attached, the head part 37 of the mandrel is accommodated in the large diameter part 36a of the inside cavity 36, and a top end part of the rod-shaped mandrel is exposed to a portion upward more than an upper surface 30a of the sealing plug 30. Then, when the sealing plug 30 is attached to the liquid injection hole 25, the shaft part 32 configured as described above is kept to be inserted into the liquid injection hole 25 and then the mandrel is pulled upward so as to move the head part 37 to the small diameter part 36b at an upper part of the shaft part 32. By doing this, plastic deformation is caused on the shaft part 32 and thus the lock part 38 is formed on an outer circumferential surface of the shaft part 32. Then, by this lock part 38 being locked to the inner surface 22b of the sealing plate 22, the sealing plug 30 is fixed to the sealing plate 22. After that, the mandrel is cut off and removed from the head par 37.

At that time, the flange part 34 of the sealing plug 30 is opposed to the outer surface 22a of the sealing plate 22. Then, the sealing member 40 is arranged between the outer surface 22a of the sealing plate 22 and an opposed surface 34a of the flange part 34. The sealing member 40 is a disk-shaped member on which a circular-shaped opening part 40a is formed at a central portion. Into the opening part 40a of this sealing member 40, the shaft part 32 of the sealing plug 30 is inserted. Then, the sealing member 40 is disposed and pressurized between the flange part 34 of the sealing plug 30 and the sealing plate 22. By doing this, the gap between the sealing plug 30 and the sealing plate 22 is closed, and thus it is possible to inhibit the liquid leakage of the electrolyte. Incidentally, for attaching this kind of sealing plug 30, the pressure applied to the sealing member 40 can be set to be within a range of 50 N to 800 N (for example, about 400 N).

Here, if the sealing member 40 is degradated due to exposure to a high temperature environment or the like, the pressure coming from the sealing plug 30 and the sealing plate 22 makes the sealing member 40 be deformed toward an outside in a diameter direction with the liquid injection hole 25 (shaft part 32 of the sealing plug 30) treated as a center. However, regarding the sealed battery 1 in accordance with the present embodiment, a rough surface area R is formed on each of the outer surface 22a of the sealing plate 22 and the opposed surface 34a of the flange part 34. By doing this, a friction resistance between the sealing plate 22 and the sealing member 40 and a friction resistance between the flange part 34 and the sealing member 40 are increased, and thus it is possible to regulate the deformation of the sealing member 40 toward an outside in the diameter direction. Therefore, according to the present embodiment, it is possible to suitably suppress the liquid leakage caused by the degradated deformation of the sealing member 40.

Incidentally, the term “rough surface area” in the present specification means an area whose surface has an arithmetic average roughness Sa being equal to or more than 1 μm. It has been confirmed with an experiment that, by making the metal member including the rough surface area as described above contact with a resin-made member, degradated deformation of this resin member (sealing member) can be regulated. Incidentally, from a perspective of suitably regulating the degradated deformation of the sealing member, the arithmetic average roughness Sa of the rough surface area is preferably equal to or more than 1.2 μm, further preferably equal to or more than 1.4 μm, furthermore preferably equal to or more than 1.6 μm, or in particular preferably equal to or more than 1.8 μm. On the other hand, from a perspective of regulating the degradated deformation of the sealing member, the upper limit of the arithmetic average roughness Sa of the rough surface area is not particularly restricted. However, from a perspective of simplifying a process for forming the rough surface area so as to enhance manufacture efficiency, the arithmetic average roughness Sa of the rough surface area is preferably equal to or less than 100 μm, further preferably equal to or less than 50 μm, furthermore preferably equal to or less than 25 μm, or in particular preferably equal to or less than 10 μm. Incidentally, the term “arithmetic average roughness Sa” in the present specification means an arithmetic average roughness Sa defined by ISO25178.

In addition, a maximum height Sz of the rough surface area is preferably equal to or more than 15 μm, further preferably equal to or more than 20 μm, or in particular preferably equal to or more than 25 μm, By forming the rough surface area having a larger maximum height Sz on a surface of the metal member contacting with the sealing member, it is possible to furthermore suitably regulate the degradated deformation of the sealing member. On the other hand, from a perspective of simplifying a process of forming the rough surface area so as to enhance manufacture efficiency, the maximum height Sz of the rough surface area is preferably equal to or less than 200 μm, further preferably equal to or less than 150 μm, furthermore preferably equal to or less than 100 μm, or in particular preferably equal to or less than 50 μm.

In addition, the process for forming the rough surface area on a surface of the metal member (sealing plate 22 or flange part 34) does not restrict the herein-disclosed technique, and therefore a conventionally known roughening process can be used without particular restriction. For the roughening process as described above, it is possible to use a plating process, an edging process, an electrolytic polishing, a chemical polishing, a blast processing, a laser processing, or the like. In addition, it is preferable that the rough surface area is formed on an area equal to or more than 5% of a surface contacting with the sealing member (further suitably equal to or more than 20% or furthermore suitably equal to or more than 50%). By doing this, it is possible to suitably regulate the degradated deformation of the sealing member. In addition, the upper limit of the size of the rough surface area, which is not particularly restricted, might be 100% of the contact surface with the sealing member, might be equal to or less than 90%, night be equal to or less than 80%, or might be equal to or less than 70%.

In addition, a material of the sealing member 40 is not particularly restricted, and thus a material used in a conventionally known sealed battery can be used without particular restriction. As one example for a material of this sealing member 40, it is possible to use polypropylene (PP), fluorinated resin (PFA), tetrafluoroethylene-hexafluoropropylene copolymer (FEP), tetrafluoroethylene-ethylene copolymer (ETFE), polytetrafluoroethylene (PTFE), ethylene propylene rubber (EPDM), fluorine rubber, or the like. These resin materials tend to be deformed by degradation with comparative ease, but it is possible to suitably regulate the degradated deformation by making each of these resin members contact with a rough surface area whose arithmetic average roughness Sa is equal to or more than 1 μm.

In addition, regarding the sealed battery 1 in accordance with the present embodiment, a projection part 35 is formed on the opposed surface 34a of the flange part 34, and the projection part is configured in a ring shape to protrude toward the sealing member 40 and to surround the liquid injection hole 25 in a plane view. The projection part 35 surrounding the liquid injection hole 25 as described above can interrupt deformation of the sealing member 40 to an outward in the diameter direction with the liquid injection hole 25 being treated as a center, and thus it is possible to further suitably suppress the liquid leakage caused by the degradated deformation of the sealing member 40.

### Another Embodiment

Above, one embodiment for the herein-disclosed technique has been explained. Incidentally, the above-described Embodiment 1 is to show an example of the sealed battery in which the herein-disclosed technique is applied, and this embodiment is not intended to restrict the herein-disclosed technique.

For example, it is enough for the rough surface area to be formed on at least a part of a portion of the surface of the battery case and/or the opposed surface of the sealing plug contacting with the sealing member, and the rough surface area is not restricted to the above described area shown in Embodiment 1. In particular, the Embodiment 1 includes the rough surface area R formed on each of the outer surface 22a of the sealing plate 22 and the opposed surface 34a of the flange part 34. However, the surface on which the rough surface area R is formed might be any one of the outer surface 22a of the sealing plate 22 and the opposed surface 34a of the flange part 34. Even in that case, it is possible to sufficiently suppress the liquid leakage caused by degradated deformation of the sealing member 40. In addition, the Embodiment 1 includes the sealing member arranged between the sealing plate 22 and the flange part 34, However, the sealing member is not restricted to the above described embodiment, and it is possible to arrange the sealing member at a desired position between the battery case and the sealing plug. For example, the sealing member can be arranged between the lock part of the sealing plug (see the lock part 38 in FIG. 2) and the sealing plate. In that situation, it is preferable that the rough surface area is formed on an opposed surface (upper surface) of the lock part being opposed to the sealing plate. By doing this, it is possible to suitably regulate the deformation of the sealing member arranged inside the battery case.

In addition, regarding the sealed battery 1 in accordance with Embodiment 1, the liquid injection hole 25 is provided on the sealing plate 22 of the battery case 20. However, the position of the liquid injection hole is not restricted to the sealing plate, and it is enough for the liquid injection hole to be provided on any one surface of the wall surfaces configuring the box-shaped case body. However, in consideration of the operation efficiency for attaching the sealing plug, it is preferable that the liquid injection hole is formed on the sealing plate.

In addition, regarding the sealed battery 1 in accordance with Embodiment 1, the ring-shaped projection part 35 surrounding the liquid injection hole 25 is formed on the opposed surface 34a of the flange part 34. However, the ring-shaped projection part 35 as described above does not restrict the herein-disclosed technique. For example, the projection part surrounding the liquid injection hole might be formed on the outer surface 22a of the sealing plate 22 in FIG. 2. Even in that situation, it is possible to interrupt the deformation of the sealing member 40 toward an outward in the diameter direction. In addition, even if the projection part is not formed, it is possible to sufficiently regulate the deformation of the sealing member toward the outward in the diameter direction. The rough surface area, which is a feature of the herein-disclosed sealed battery, includes an advantage of implementing higher degree of freedom at the forming time and of implementing easier formation even on a fine part, is comparison with a ring-shaped projection part molded by a pressing process, or the like. In other words, the rough surface area can induce a remarkable effect especially for enhancing the sealed property for a fine structure, such as the sealing plug.

### Test Example

Below, a test example related to the present disclosure will be explained.

Incidentally, a content of the test example described below is not intended to restrict the present disclosure.

1. Preparing Sample

(Sample 1)

In the present test, as an object for the rough surface process, an aluminum plate, thickness 2 mm×width 20 mm×depth 20 mm, was prepared. Then, on sample 1, the roughening process with a laser processing was performed so as to form the rough surface area on a surface of the aluminum plate. In particular, a laser irradiation apparatus (3-Axis fiber laser marker made by KEYENCE corporation, model: MD-F3200) was used to irradiate pulse laser on the surface of the aluminum plate so as to form the rough surface area whose size was 5 mm×5 mm. Incidentally, regarding the roughening process for the sample 1, an output of the laser was 30 W, a scanning speed was 100 mm/sec, and a pulse energy was 5 J/pulse.

(Sample 2)

Sample 2 in the present test is an un-processed aluminum plate on which the roughening process by laser irradiation is not performed.

2. Evaluation Test

(1) Measuring Surface Roughness

In the present test, regarding each sample after the roughening process, an arithmetic average roughness Sa and a maximum height Sz were measured. These measurements were performed with a contactless inspection device (model: VK-X130) made by KEYENCE corporation. Measurement results are shown in Table 1.

(2) Durability Test

A disk-shaped resin washer (diameter: about 5.7 mm, thickness: about 0.4 mm) made from PFA resin was prepared and then arranged on the sealing plate (made of aluminum) of the sealed battery. Then, the aluminum plates of samples 1 to 2 were overlaid on a resin washer and pressurized at 250 N pressure, and then this state was held. Incidentally, regarding samples 1 and 2, an aluminum plate was arranged so as to make the surface, on which the roughening process was performed, directly contact with the resin washer. Then, the resultant was arranged under a 60° C. environment while keeping the pressurized state, so that the durability test of storing for 150 hours was performed. Then, after 150 hours passed, the storing temperature was risen to be 100° C. and then further 15 hours storage was performed. In the present test, a diameter of the resin washer was measured at each time point among before pressurizing, after pressurizing, 1 hour later since the storage, 25 hours later since the storage, 50 hours later since the storage, 100 hours later since the storage, 150 hours later since the storage, and 165 hours later since the storage. Measurement results are shown in Table 1.

TABLE 1

| | | Sample 1 | Sample 2 |
|---|---|---|---|
| Surface | Average roughness Sa | 1.93 | 0.89 |
| roughness | Maximum height Sz | 26.56 | 8.99 |
| (μm) | | | |
| Diameter | Before pressurizing | 5.789 | 5.792 |
| (mm) | Immediately after pressurizing | 5.933 | 5.969 |
| | 1 hour later since storage | 5.938 | 5.971 |
| | 25 hour later since storage | 5.943 | 5.995 |
| | 50 hour later since storage | 5.933 | 5.990 |
| | 100 hour later since storage | 5.924 | 5.988 |
| | 150 hour later since storage | 5.933 | 5.978 |
| | 165 hours later since storage | 5.938 | 5.985 |
| | (temperature risen to be 100° C.) | | |
| | After-pressurizing | 0.144 | 0.177 |
| | deformation amount | | |
| | After-heating | 0.005 | 0.017 |
| | deformation amount | | |

As shown in Table 1, regarding sample 2, “after-heating deformation amount” representing a difference of a diameter at the time immediately after pressurizing and a diameter at the time 165 hours later since the storage of the resin washer was 0.017 mm. It can be understood that the increase in the diameter described above was caused by diameter expansion due to the pressure as the result of long period storage under a high temperature environment and then as the result of degradation of the resin washer reducing the rebound force. On the other hand, regarding sample 1, the after-heating deformation amount was suppressed to be 0.005 mm. This can be understood that the roughening process increased the friction resistance between the aluminum plate and the resin washer and thus the diameter expansion of the resin washer was regulated. For a general sealed battery, in order to inhibit the liquid leakage of the electrolyte, it is required to control a manufacture tolerance of the resin washer at a level equal to or less than 0.01 mm. In other words, in consideration of being able to suppress the deformation amount after exposed to a 100° C. high temperature environment to be about 0.005 mm, it was found that forming the rough surface area on the surface of the metal member (sealing plug) contacting with the resin washer was very suitably used as a technique of suppressing the liquid leakage of the electrolyte.

In addition, as shown by “after-heating deformation amount” in Table 1, it was found regarding the sample 1 that the diameter expansion of the resin washers before and after the pressurizing process can be properly regulated. Even from the perspective as described above, it is understood that forming the rough surface area on the surface of the metal member (sealing plug) contacting with the resin washer can be suitably used too much as the technique of suppressing the liquid leakage of the electrolyte.

Although the present disclosure is explained above in details, the above described explanation is merely an illustration. In other words, the herein-disclosed technique contains ones in which the above described specific examples are deformed or changed.

What is claim is:

1. A sealed battery, comprising:
a battery case that comprises a liquid injection hole;
a sealing plug that is attached to the liquid injection hole and that comprises an opposed surface opposed to a surface of the battery case at a periphery of the liquid injection hole; and
a sealing member that is made of resin and that is disposed between the battery case and the sealing plug, wherein
the surface of the battery case and/or the opposed surface of the sealing plug comprises a rough surface area on at least a part of a portion contacting with the sealing member, and
an arithmetic average roughness Sa of the rough surface area is equal to or more than 1 μm.

2. The sealed battery according to claim 1, wherein
the sealing plug comprises:
a shaft part that is inserted into the liquid injection hole; and
a flange part that is formed in a plate shape and extends from the shaft part along an outer surface of the battery case at an outside of the battery case,
the sealing member is disposed between the outer surface of the battery case and an opposed surface of the flange part, and
the outer surface of the battery case and/or the opposed surface of the flange part comprises the rough surface area on at least a part of a portion contacting with the sealing member.

3. The sealed battery according to claim 1, wherein
a projection part is formed on the surface of the battery case and/or the opposed surface of the sealing plug, and
the projection part is configured to protrude toward the sealing member and configured to surround the liquid injection hole in a plane view.

4. The sealed battery according to claim 1, wherein
the surface of the battery case and/or the opposed surface of the sealing plug comprises the rough surface area on a part equal to or more than 5% of the portion contacting with the sealing member.

5. The sealed battery according to claim 1, wherein
the arithmetic average roughness Sa of the rough surface area is equal to or less than 100 μm.
